(19) United States
(12) Patent Application Publication
(10) Pub. No.: US 2005/0138213 A1
(43) Pub. Date: Jun. 23, 2005

(54) Open cable applying apparatus and method of allowing internet

(76) Inventors: Sang-jun Lee, Yongin-si (KR); Tae-yong Son, Suwon-si (KR)

Correspondence Address: STANZIONE & KIM, LLP, 1740 N STREET, N.W., FIRST FLOOR, WASHINGTON, DC, 20036, US

(21) Appl. No.: 10/961,151

(22) Filed: Oct. 12, 2004

(30) Foreign Application Priority Data
Dec. 23, 2003 (KR) 2003-95511

(51) Int. Cl. G06F 15/16

(52) U.S. Cl. 709/250

(57) ABSTRACT

An open cable applying apparatus capable of providing an internet search and an internet providing method using the applying apparatus. The open cable applying apparatus includes a PCMCIA interface unit to mount any one of a POD module and a LAN card having PCMCIA (Personal Computer Card International Association) standards, a web browser driving unit to drive a web browser to generate a certain web page, and a control unit to switch the mode in the apparatus to an internet mode if it is determined that the LAN card having PCMCIA standards is mounted on the PCMCIA interface unit and then controlling the web browser driving unit so that the driving unit may stand-by the driving of the web browser. Accordingly, it is possible to provide an open cable applying apparatus capable of performing an internet search using a LAN card having PCMCIA standards.

### CROSS-REFERENCE TO RELATED APPLICATIONS

This application claims benefit under 35 U.S.C. § 119 from Korean Patent Application No. 2003-95511 filed on Dec. 23, 2003, the entire content of which is incorporated herein by reference.

### BACKGROUND OF THE INVENTION

1. Field of the Invention

The present general inventive concept relates to an open cable applying apparatus capable of providing an internet search, and an internet providing method using the same. More particularly, the present general inventive concept relates to an open cable applying apparatus capable of performing an internet search using a PCMCIA interface, and an internet providing method using the same.

2. Description of the Related Art

An open cable set-top box selectively receives a broadcasting signal depending on whether or not a POD (Point of Development Module) is mounted. If the POD module is mounted, the open cable set-top box processes a toll broadcasting signal as a viewable signal. If the POD module is not mounted, the open cable set-top box cannot process a toll broadcasting signal as a viewable signal. This is because a POD module provides a conditional access system to the subscriber of the open cable set-top box.

In general, the open cable set-top box comprises a PCMCIA (Personal Computer Memory Card International Association) interface to expand its function. Accordingly, the POD module having PCMCIA standards may be mounted on the PCMCIA interface. PCMCIA stands for international association that has been established to support the compatibility between expansion equipment such as a LAN (Local Area network) card and personal computers. Products employing such PCMCIA standards include various products such as a flash memory, a modem, a LAN card, and a hard disk drive (HDD), as well as the POD module described above.

However, even though the expandability of the prior art open cable set-top box is supported by the PCMCIA interface, the set-top box receives only data such as a digital broadcasting signal or an electronic program guide (EPG), and is not able to provide other functions.

### SUMMARY OF THE INVENTION

The present general inventive concept has been developed in order to solve the above drawbacks and other problems associated with the conventional arrangement. Therefore, the present general inventive concept provides an open cable applying apparatus capable of performing internet searches using a PCMCIA interface having expandability, and an internet providing method of the open cable applying apparatus thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an open cable applying apparatus capable of providing an internet search by comprising a Personal Computer Card International Association (PCMCIA) interface unit to mount any one of a point of deployment (POD) module and a local area network (LAN) card complying with PCMCIA standards, a web browser driving unit to drive a web browser to generate a certain web page, and a control unit to switch the mode of the apparatus to an internet mode if it is determined that the LAN card having PCMCIA standards is mounted on the PCMCIA interface unit and then to control the web browser driving unit so that the driving unit may stand-by the driving of the web browser.

Specifically, if the LAN card having PCMCIA standards is mounted on the PCMCIA interface unit, the control unit can allow OOB (Out of Band) lines used where the POD module is mounted to be used as address lines to control the LAN card.

In an aspect of the present general inventive concept, after switching to the internet mode of the apparatus, the control unit controls the web browser driving unit so that the driving unit is communicatively connected to a certain server through the LAN card to generate the web page.

In an aspect of the present general inventive concept, the control unit confirms identification information stored in the replaced LAN card, thereby recognizing the mounting of the LAN card.

Also, the open cable applying apparatus may further comprise a display displaying the generated web page.

The foregoing and/or other aspects and advantages of the present general inventive concept are also achieved by providing an internet providing method of an open cable applying apparatus by comprising operations of mounting any one of a point of deployment (POD) module and a local area network (LAN) card complying with PCMCIA standards, switching the mode of the applying apparatus to an internet mode if it is determined that the LAN card having PCMCIA standards is mounted, and standing-by the driving of a web browser generating a certain web page.

The method may further comprise after the operation of standing-by the driving of a web browser, driving the web browser so that it is connected to a certain server to generate the web page if the LAN card is communicatively connected to the certain server.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram illustrating an open cable applying apparatus capable of providing an internet search according to an exemplary embodiment of the present general inventive concept;

FIG. 2A is a schematic view illustrating a signal flow where a POD module is connected to the apparatus of FIG. 1;

FIG. 2B is a schematic view illustrating a signal flow where a LAN card is connected to the apparatus of FIG. 1;

FIG. 3 is a flowchart illustrating an internet providing method using the apparatus of FIG. 1, according to another exemplary embodiment of the present general inventive concept;

FIG. 4A is a view illustrating an example of a screen displayed on a television where a POD module is connected to the apparatus of FIG. 1; and

FIG. 4B is a view illustrating an example of a screen displayed on a television where a LAN card is connected to the apparatus of FIG. 1.

### DETAILED DESCRIPTION OF THE PREFERRED EMBODIMENTS

Certain embodiments of the present general inventive concept will be described in greater detail with reference to the accompanying drawings.

In the following description, the same drawing reference numerals are used for the same elements even in different drawings. The matters defined in the description such as detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the invention in unnecessary detail.

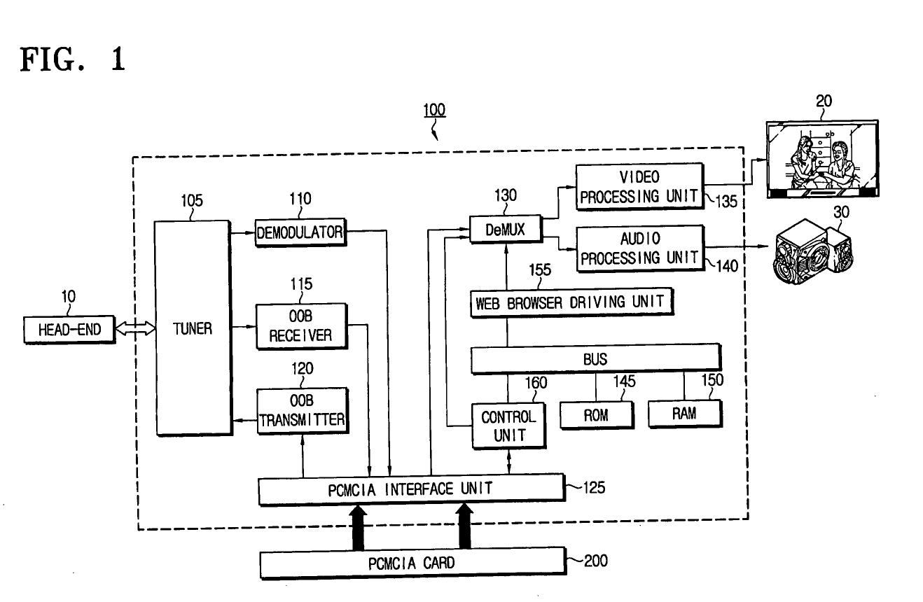

FIG. 1 is a schematic block diagram illustrating an open cable applying apparatus capable of providing an internet search according to an exemplary embodiment of the present general inventive concept.

Referring to FIG. 1, the open cable applying apparatus 100 capable of providing an internet search comprises a tuner 105, a demodulator 110, an OOB (Out of Band) receiver 115, an OOB transmitter 120, a PCMCIA interface unit 125, a demultiplexer 130 (hereinafter, referred to as ‘DeMUX’), a video processing unit 135, an audio processing unit 140, a ROM (read only memory) 145, a RAM (random access memory) 150, a web browser driving unit 155 and a control unit 160.

In FIG. 1, only blocks associated with the present general inventive concept are shown, and other blocks are omitted for clarity and conciseness. Also, the bold arrows in FIG. 1 indicate that a PCMCIA card 200 is mounted on the PCMCIA interface unit 125.

First, the open cable applying apparatus 100 shown in FIG. 1 supports an open cable mode and a POD function and includes, for example, an open cable set-top box. Also, if a LAN card is mounted in place of a POD module, the open cable applying apparatus 100 according to an exemplary embodiment of the present general inventive concept provides an internet search function. At this time, a POD module and the replacement LAN card are represented by the PCMCIA card 200 having PCMCIA standards. The POD module supports a POD function that descrambles the scrambled digital contents, and a LAN card is connected to an internet network to provide the internet search function.

The tuner 105 selects a certain channel out of the digital contents (hereinafter, referred to as ‘broadcasting signal’) sent out from a head-end 10. The head-end 10 is a signal relay for a cable broadcasting. The demodulator 110 demodulates the broadcasting signal of the selected channel.

If the PCMCIA card mounted on the PCMCIA interface unit 125 is the POD module, POD module descrambles the demodulated broadcasting signal. The descrambled broadcasting signal is input to the DeMUX 130. The DeMUX 130 demultiplexes the descrambled broadcasting signal so that the video signal may be provided to the video processing unit 135 and the audio signal may be provided to the audio processing unit 140.

The video processing unit 135 processes an input video signal as a displayable signal. For example, the video processing unit 135 decodes an input MPEG-2 TS (Transport Stream). Furthermore, the video processing unit 135 processes as a displayable signal a web page supplied from the web browser driving unit 155 that will be described below.

The audio processing unit 140 decodes an input audio signal into an audible signal.

The POD module performs a two-way communication with the head-end 10 using the OOB receiver 115 and the OOB transmitter 120. As an example, the POD module interprets instructions received from the head-end 10 through the OOB receiver 115, and then performs the interpreted instructions from the head-end 10 while communicating with the control unit 160. The POD module sends the commands requested by the user to the head-end 10 through the OOB transmitter 120.

The PCMCIA interface unit 125 is an interface compliant to PCMCIA standards having 68 lines (or 68 pins), and the functions of a part of the lines are modified depending on the type of PCMCIA card 200. In other words, the properties of signals transmitted through the part lines are modified. In this exemplary embodiment, since a POD module or a LAN card is applied as the PCMCIA card 200, the functions of a desired number of lines are modified according to the POD module or LAN card.

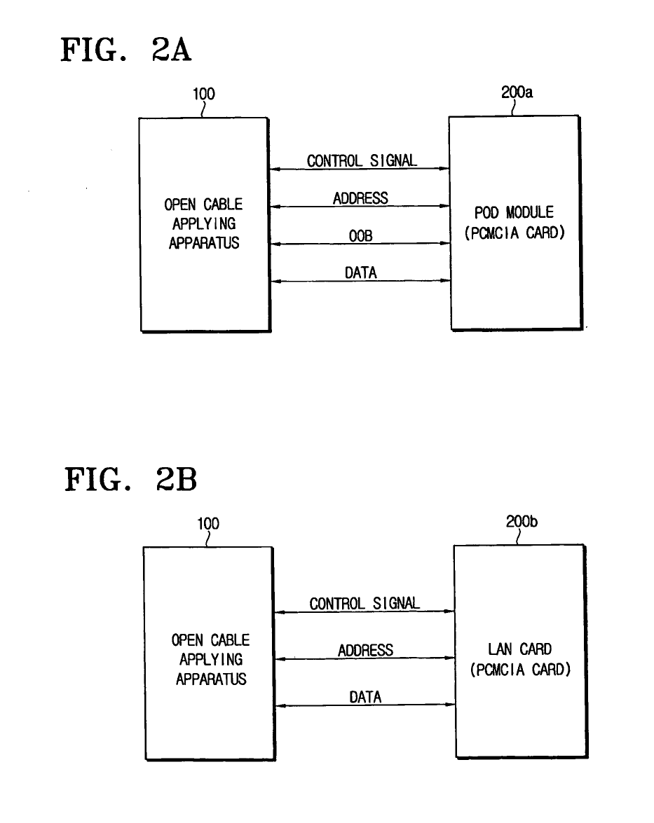

FIG. 2A illustrates the signal flow where the POD module is connected to the apparatus of FIG. 1, and FIG. 2B illustrates the signal flow where the LAN card is connected to the apparatus of FIG. 1.

Referring to FIG. 2A, if the POD module 200a is mounted on the PCMCIA interface unit 125, the PCMCIA interface unit 125 transmits a control signal (Control Signal), an address signal (Address), an OOB signal (OOB), and a data signal (DATA) through 68 lines.

With reference to FIG. 2B, if the LAN card 200b is mounted on the PCMCIA interface unit 125, the PCMCIA interface unit 125 transmits a control signal (Control Signal), an address signal (Address), and a data signal (DATA) through 68 lines. That is, when the LAN card 200b is mounted on the PCMCIA interface unit 125, at least one line of OOB signal lines is used as an address line to control the LAN card 200b.

Referring back to FIG. 1,the ROM 145 is a non-volatile memory element and is stored with various programs necessary to implement the functions of the open cable applying apparatus 100. The ROM 145 is stored with identification information capable of identifying the type of the PCMCIA card 200 mounted on the PCMCIA interface unit 125. In other words, the ROM 145 is stored with different identification information for the type of the PCMCIA card 200.

The RAM 150 is a volatile memory element, and is loaded and stored with programs executed by the control unit 160 or is stored with the resultant data processed by the control unit 160.

The web browser driving unit 155 is a memory element stored with a web program, and includes, for example, a flash memory. The web program is a program that drives the web browser to generate a certain web page, and may include, for instance, Explorer or Netscape.

The web browser driving unit 155 is set to a stand-by state to drive the web browser when the LAN card 200b is mounted on the PCMCIA interface unit 125. Alternately, the web browser driving unit 155 may be connected to a server corresponding to URL (Uniform Resource Locator) that is previously set to generate a certain web page when the LAN card 200b is mounted on the PCMCIA interface unit 125. The generated web page is signal-processed by the video processing unit 135 and output.

The control unit 160 allows overall operations of the present apparatus to be performed by driving the pre-set various programs. In this exemplary embodiment, the control unit 160 determines the type of the PCMCIA card 200 mounted on the PCMCIA interface unit 125. For example, the control unit 160 reads out the identification information ID stored in the PCMCIA card 200, and then compares the read-out ID with ID stored on the ROM 145, thereby determining the type of the PCMCIA card 200. Then, the control unit 160 resets the hardware configurations according to the type determined, and then allows the corresponding software applications to be executed.

If it is determined that the POD module 200a is mounted on the PCMCIA interface unit 125, the control unit 160 controls the DeMUX 130, the video processing unit 135 and the audio processing unit 140 so that the signal that is descrambled by the POD module 200a is processed as a displayable signal.

If it is determined that the LAN card 200b is mounted on the PCMCIA interface unit 125, the control unit 160 switches the mode of the open cable applying apparatus 100 to the internet mode, and then controls the web browser driving unit 155 so that the driving unit 155 may stand-by the driving of the web browser. At this time, the control unit 160 resets the hardware configurations to allow a part of the OOB lines to be used as address lines, as shown in FIG. 2B.

Alternatively, after switching to the internet mode of the open cable applying apparatus 100, the control unit 160 controls the web browser driving unit 155 so that the driving unit 155 is connected to a server corresponding to a URL that is previously set to generate a certain web page. The web page is generated where the LAN card 200b is communicatively connected to an internet network through a LAN cable (not shown). If the LAN card is not communicatively connected to the internet network, the control unit 160 allows a guide message such as ‘Please confirm whether or not LAN card is connected with LAN cable’ to be generated.

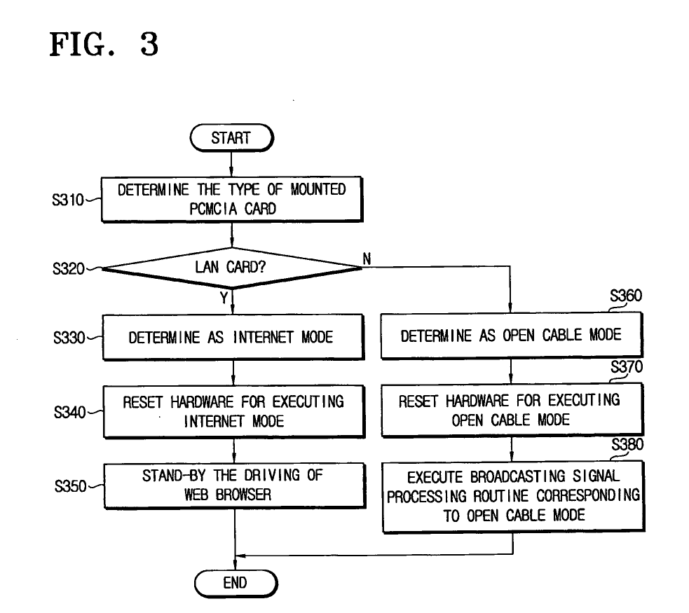

FIG. 3 is a flowchart illustrating an internet providing method using the apparatus of FIG. 1.

With reference to FIG. 1 to FIG. 3, the control unit 160 determines the type of the PCMCIA card 200 mounted on the PCMCIA interface unit 125 at operation S310. Operation S310 is performed where the power source of the open cable applying apparatus 100 is turned-on or the PCMCIA card 200 is replaced. In the operation S310, the control unit 160 confirms ID stored in the memory of the PCMCIA card 200, and determines that if the confirmed ID corresponds to one of IDs stored in the ROM 145, the type mapped to the corresponding ID is mounted.

In the operation S310, if it is determined that the mounted PCMCIA card 200 is the LAN card 200b, the control unit 160 switches the mode in the open cable applying apparatus 100 to the internet mode at operations S320 and S330. The control unit 160 resets the hardware configurations for the execution of the internet mode at operation S340.

The operation S340 includes the operation of reconfiguring the hardware connections of the PCMCIA interface to allow the LAN card 200b to be operated. That is, the control unit 160 resets the hardware connections of the PCMCIA interface to allow a part or all of the OOB lines out of 68 lines provided on the PCMCIA interface unit 125 to be used as address lines.

When the operation S340 has been performed, the control unit 160 controls the web browser driving unit 155 so that the driving unit 155 may stand-by the driving of the web browser. Subsequent to the operation S350, if the LAN card 200b is communicatively connected to a certain server through a LAN cable (not shown), the control unit 160 controls the web browser driving unit 155 to generate a certain web page.

The certain web page is an initial screen displayed when driving an initial web browser, and the URL of the web page is previously set in the open cable applying apparatus 100. The displayed web page is modified by the demand of the user.

Meanwhile, if it is determined that the mounted PCMCIA card 200 is the POD module 200a, the control unit 160 switches the mode of the open cable applying apparatus 100 to the open cable mode at operation S360. The control unit 160 resets the hardware configurations for the execution of the open cable mode at operation S370. For example, the control unit 160 resets the hardware connections of 68 lines provided on the PCMCIA interface unit 125 to allow the POD module 200a to be operated.

When the operation S370 has been performed, the control unit 160 allows the broadcasting signal processing routine corresponding to the open cable mode to be executed at operation S380. For example, the control unit 160 executes the software applications decoding the broadcasting signal that is selected by the tuner 105. Thus, the broadcasting signal descrambled by the POD module is decoded by the video processing unit 135 and the audio processing unit 140 and supplies to a display 20 and a speaker 30, respectively.

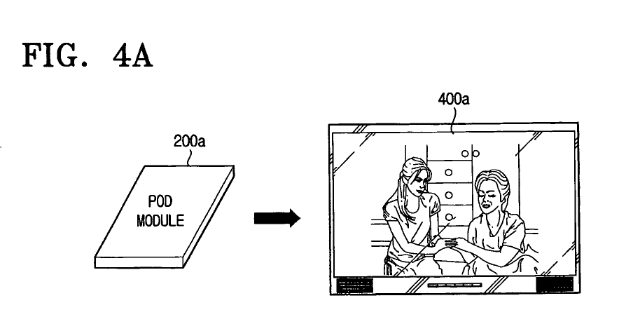

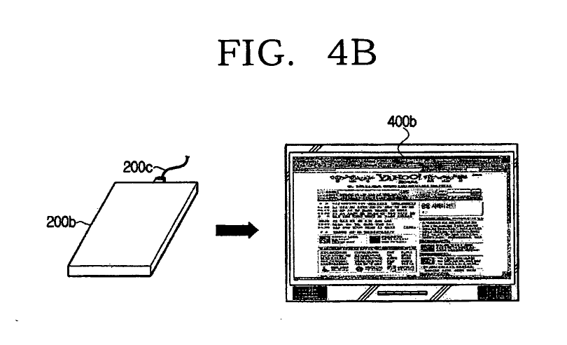

FIG. 4A illustrates an example of a screen displayed on a television where the POD module is connected to the apparatus of FIG. 1, and FIG. 4B illustrates an example of a screen displayed on a television where the LAN card is connected to the apparatus of FIG. 1.

When the POD module 200a is mounted on the PCMCIA interface unit 125 of FIG. 1, the broadcasting screen 400a of a prescribed channel is displayed on the TV connected to the open cable applying apparatus 100, as shown in FIG. 4A. When the LAN card 200b is mounted on the PCMCIA interface unit 125 of FIG. 1, the internet search screen 400b is displayed on the TV connected to the open cable applying apparatus 100, as shown in FIG. 4B.

The open cable applying apparatus 100 according to an exemplary embodiment of the present general inventive concept described above is applicable to an open cable TV as well as an open cable set-top box.

As described so far, in accordance with an open cable applying apparatus capable of providing an internet search and an internet providing method using the same according to the present invention, it is possible to provide an internet search function as well as an open cable broadcasting using one PCMCIA interface. In other words, it is possible to watch the open cable broadcasting when the POD module is mounted on the PCMCIA interface, and it is possible to perform an internet search when the LAN card is mounted on the PCMCIA interface. This is because the POD module supports the open cable mode and the LAN card supports the internet mode support PCMCIA interface system.

The present general inventive concept can be realized as a method, an apparatus, and a system. When the present general inventive concept is manifested in computer software, components of the present general inventive concept may be replaced with code segments that are necessary to perform the required action. Programs or code segments may be stored in media readable by a processor, and transmitted as computer data that is combined with carrier waves via a transmission media or a communication network.

The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electromagnetic field, RF network, etc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An open cable applying apparatus capable of providing an internet search, comprising:
a Personal Computer Card International Association (PCMCIA) interface unit to mount any one of a point of deployment (POD) module and a local area network (LAN) card complying with PCMCIA standards;
a web browser driving unit to drive a web browser to generate a certain web page; and
a control unit to switch the mode of the apparatus to an internet mode if it is determined that the LAN card having PCMCIA standards is mounted on the PCMCIA interface unit and then to control the web browser driving unit so that the driving unit may stand-by the driving of the web browser.

2. The apparatus as claimed in claim 1, wherein if the LAN card having PCMCIA standards is mounted on the PCMCIA interface unit, the control unit allows OOB (Out of Band) lines used where the POD module is mounted to be used as address lines to control the LAN card.

3. The apparatus as claimed in claim 1, wherein after switching to the internet mode of the apparatus, the control unit controls the web browser driving unit so that the driving unit is communicatively connected to a certain server through the LAN card to generate the web page.

4. The apparatus as claimed in claim 3, further comprising a display displaying the generated web page.

5. The apparatus as claimed in claim 1, wherein the control unit confirms identification information stored in the replaced LAN card, thereby recognizing the mounting of the LAN card.

6. An internet providing method of an open cable applying apparatus, comprising the operations of:
mounting any one of a point of deployment (POD) module and a local area network (LAN) card complying with PCMCIA standards;
switching the mode of the applying apparatus to an internet mode if it is determined that the LAN card having PCMCIA standards is mounted; and
standing-by the driving of a web browser generating a certain web page.

7. The method as claimed in claim 6, wherein, if the LAN card is mounted, OOB (Out of Band) lines used where the POD module is mounted are used as address lines to control the LAN card.

8. The method as claimed in claim 6, further comprising after the operation of standing-by the driving of a web browser generating a certain web page,
driving the web browser so that it is connected to a certain server to generate the web page if the LAN card is communicatively connected to the certain server.

9. The method as claimed in claim 6, wherein the operation of switching the mode of the applying apparatus to an internet mode if it is determined that the LAN card having PCMCIA standards is mounted determines that the POD module is replaced with the LAN card by confirming identification information stored in one of the mounted POD module and the LAN card.

10. An open cable applying apparatus, comprising:
a interface unit to mount either a point of deployment (POD) module or a local area network (LAN) card that complies with PCMCIA standards;
a web browser driving unit to drive a web browser to generate a certain web page; and
a control unit to switch the mode of the apparatus between an internet mode if it is determined that the LAN card is mounted on the interface unit or a POD mode if the POD module is mounted on the interface unit, and to control the web browser driving unit to stand-by the driving of the web browser.

11. The apparatus as claimed in claim 10, wherein if the LAN card is mounted on the interface unit, the control unit allows OOB (Out of Band) lines used where the POD module is mounted to be used as address line to control the LAN card.

12. The apparatus as claimed in claim 10, wherein after switching to the internet mode of the apparatus, the control unit controls the web browser driving unit so that the driving unit is communicatively connected to a certain server through the LAN card to generate the web page.

13. The apparatus as claimed in claim 12, further comprising a display displaying the generated web page.

14. The apparatus as claimed in claim 10, wherein the control unit confirms identification information stored in the replaced LAN card, thereby recognizing the mounting of the LAN card.

15. A computer readable storage medium containing a method of an open cable applying apparatus, comprising the operations of:
determining whether a point of deployment (POD) module or a local area network (LAN) card complying with PCMCIA standards is mounted;
switching the mode of the applying apparatus to an internet mode if it is determined that the LAN card having PCMCIA standards is mounted; and
standing-by the driving of a web browser generating a certain web page.

16. The computer readable medium as claimed in claim 15, wherein, if the LAN card is mounted, OOB (Out of Band) lines used where the POD module is mounted is used as address lines to control the LAN card.

17. The computer readable medium as claimed in claim 15, further comprising after the operation of standing-by the driving of a web browser generating a certain web page,
driving the web browser so that it is connected to a certain server to generate the web page if the LAN card is communicatively connected to the certain server.

18. The computer readable medium as claimed in claim 15, wherein the operation of switching the mode of the applying apparatus to an internet mode if it is determined that the LAN card having PCMCIA standards is mounted determines that the POD module is replaced with the LAN card by confirming identification information stored in one of the mounted POD module and the LAN card.
